(19) United States
(12) Patent Application Publication
(10) Pub. No.: US 2020/0110471 A1
(43) Pub. Date: Apr. 9, 2020

(54) PASSIVE KEYBOARD

(71) Applicant: Microsoft Technology Licensing, LLC, Redmond, WA (US)

(72) Inventor: David P. PLATT, North Bend, WA (US)

(73) Assignee: Microsoft Technology Licensing, LLC, Redmond, WA (US)

(21) Appl. No.: 16/284,550

(22) Filed: Feb. 25, 2019

Related U.S. Application Data
(60) Provisional application No. 62/740,835, filed on Oct. 3, 2018.

(51) Int. Cl. G06F 3/02; G06F 3/041

(52) U.S. Cl. CPC G06F 3/0227; G06F 3/0416; G06F 3/0202

(57) ABSTRACT

The description relates to keyboards, specifically passive keyboards that work in conjunction with a device that has a touch display. One example passive keyboard can include a relatively flexible portion that defines a base plane and that includes biasing zones that extend away from the base plane to individual key regions that define a second plane. This example can also include relatively rigid portions secured to the individual key regions. A downward force on an individual key region can overcome a resilient bias of an individual biasing zone and deform the individual key region across the first base plane. The individual biasing zone biases the individual key region back to the second plane upon removal of the downward force.

### PRIORITY

This utility patent application claims priority from U.S. Provisional Patent Application 62/740,835, filed on 2018 Oct. 3, which is hereby incorporated by reference in its entirety.

### BRIEF DESCRIPTION OF THE DRAWINGS

The accompanying drawings illustrate implementations of the concepts conveyed in the present document. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the FIG. and associated discussion where the reference number is first introduced. Where space permits, elements and their associated reference numbers are both shown on the drawing page for the reader's convenience. Otherwise, only the reference numbers are shown.

FIGS. 1-4 show perspective views of example devices and associated passive keyboards in accordance with some implementations of the present concepts.

FIG. 5A shows a perspective view of a portion of an example passive keyboard in accordance with some implementations of the present concepts.

FIGS. 5B and 5C show side elevational section views of the example passive keyboard in accordance with some implementations of the present concepts.

FIGS. 6A and 6B show graphs of example haptic snap profiles in accordance with some implementations of the present concepts.

### DESCRIPTION

The present concepts relate to a reliable passive keyboard for use with devices employing touch sensitive screens/displays. Traditional electro-mechanical keyboards employ keys that are biased upward by a mechanical assembly that includes many interrelated parts. When a user depresses an individual key of the traditional electro-mechanical keyboard, elements of the key or the mechanical assembly complete a circuit in underlying electronic components and thereby generate an electrical signal (e.g., an electro-mechanical keyboard).

Touch screen keyboards (e.g., where a keyboard image is presented on a touch display) detect the user's finger contact with the screen via methods such as optical, thermal, pressure, and/or electrical feedback to detect the user's finger contact with the touch display. An advantage of this is that the keyboard customization is limitless (i.e. key layout can be changed via software for language, gaming, emojis, custom buttons, etc.). There are two main disadvantages of touch screen keyboards. One is that the user cannot rest his/her fingers on the touch display without triggering the touch display for touch typing (user must hover fingers over screen and look at it while typing), which can slow the typing speed. Secondly, many users prefer the ‘feel’ or haptic feedback provided by the traditional electro-mechanical keyboard. For instance, the users tend to like the vertical travel, feeling of the snap, and/or the audible sound of the keys when depressed.

A disadvantage of traditional electro-mechanical keyboards is that they require electrical power and electronic coupling (wired or wireless) to a computing device. Thus, the traditional electro-mechanical keyboard is a complicated arrangement and loss of power or failure of any of the mechanical or electronic components can cause a failure of the traditional electro-mechanical keyboard. In contrast, the present passive keyboards can provide similar feel, but do not require electrical power, do not require electronic components, and employ few moving parts while providing similar feel to traditional electro-mechanical keyboards. The present implementations can also be much thinner than traditional electro-mechanical keyboards if desired.

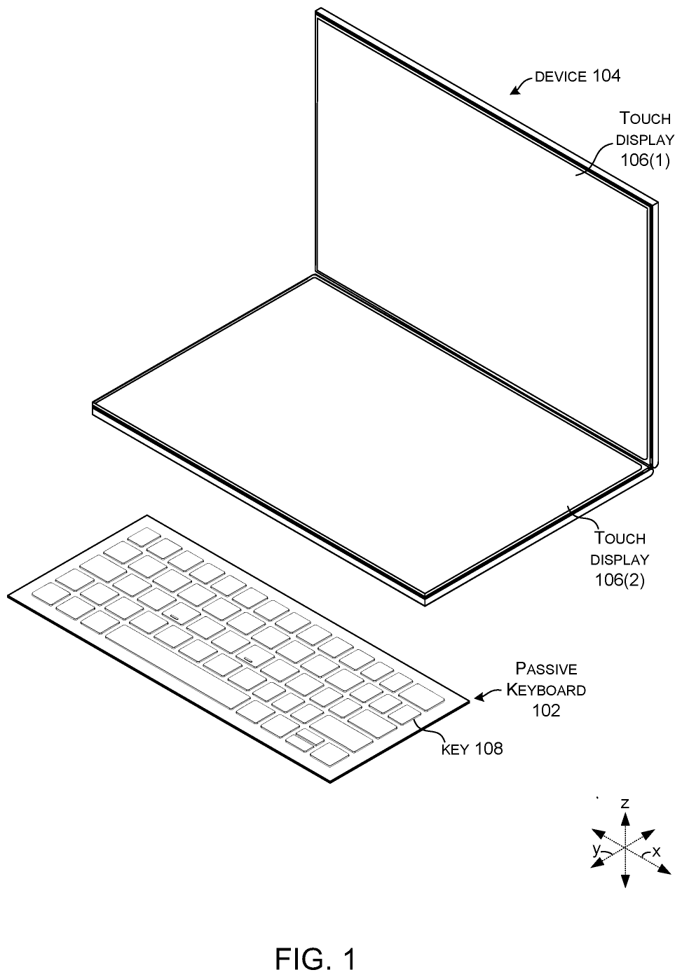

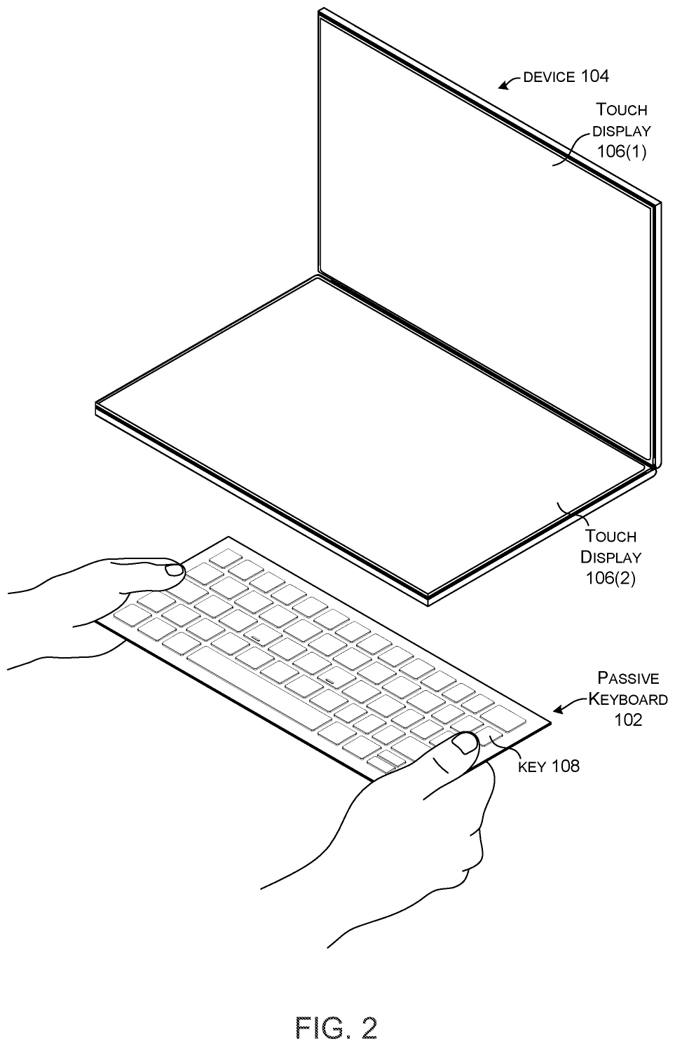

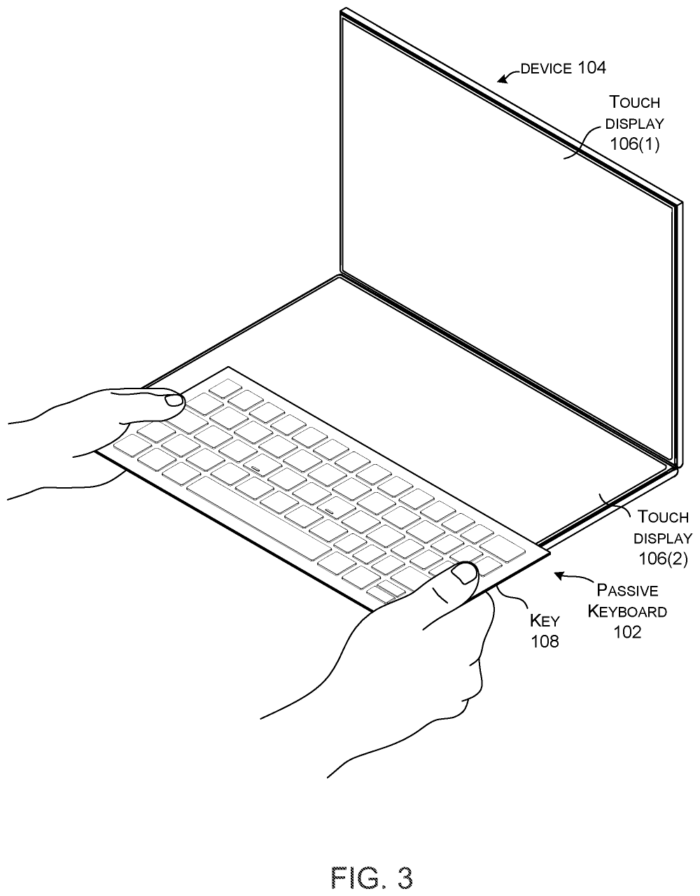

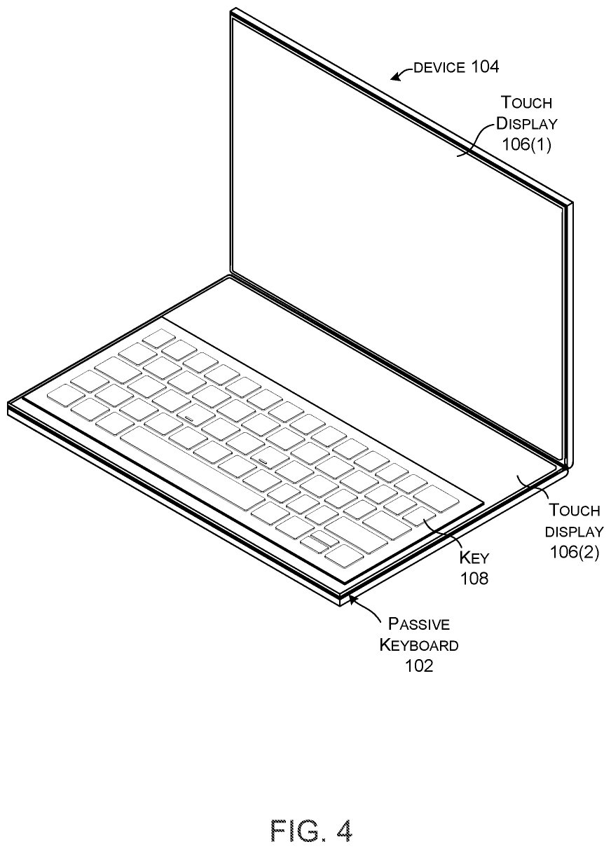

Introductory FIGS. 1-4 show an example passive keyboard or keyset 102. The passive keyboard 102 can be used with any device 104, such as the illustrated device that has a touch sensitive display 106 (e.g., touch display). In the illustrated example, the device 104 has two touch displays, but the number of touch displays is not germane to the present concepts.

If the user desires a traditional typing experience (e.g., wants to type on a keyboard that provides a similar haptic experience to traditional electro-mechanical keyboards) the user can place the passive keyboard 102 on the touch display 106. The user does not need to check to make sure the passive keyboard 102 has batteries or is turned on. The user can simply place the passive keyboard 102 on the touch display 106 and start typing.

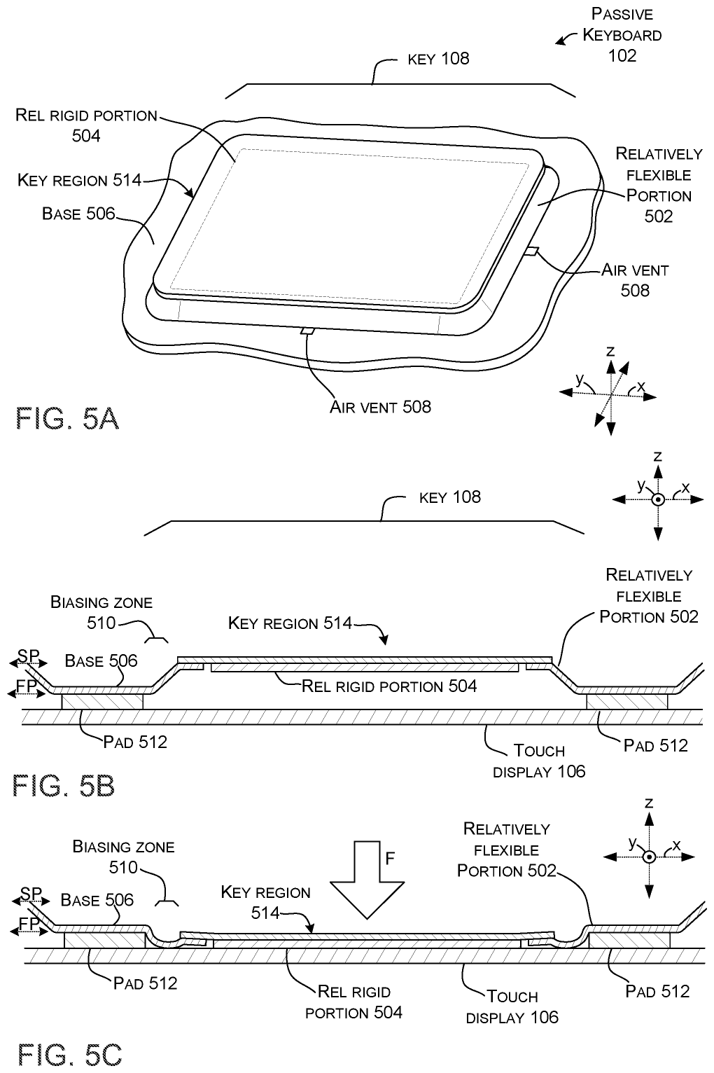

The device 104 can recognize the footprint (or some other aspect, such as an array of pads (introduced below relative to FIG. 5B) of the passive keyboard 102. The device can also contain a mapping of the location of individual keys 108 relative to (e.g., their location within) the footprint. The user can type on the passive keyboard 102 and experience the desired vertical key travel, haptic snap, and/or auditory feedback. The typing can activate the underlying touch display 106 which can output touch signals relative to the footprint. The computing device 104 can interpret the touch signals based upon the mapping. The user experience is almost identical to the traditional electro-mechanical keyboard.

In other implementations, the passive keyboard 102 and/or the device 104 may include physical alignment structures (such as magnets or pins and holes) that align the passive keyboard 102 at a specific location and orientation to the touch display 106. The presence of the passive keyboard 102 can be detected through the alignment structures. When the passive keyboard 102 is present, activation of the underlying touch display 106 can be interpreted as keystrokes.

In some implementations, the keys 108 of the passive keyboard 102 can have symbols shown thereon (e.g., printed on their surface) so that the user knows what symbol a key represents. In other implementations, the passive keyboard 102 (or at least the keys 108) can be relatively transparent and underlying portions of the touch display 106 can present symbols for the overlying keys 108. The user can see the symbols through the keys 108 and thereby knows what symbol each key represents. This latter configuration allows for an individual passive keyboard 102 to be utilized for different languages. Stated another way, the keys 108 can be viewed as generic until associated with an underlying symbol on the touch display.

FIGS. 5A-5C collectively illustrate some features of example passive keyboard 102. In some implementations, the passive keyboard 102 can include relatively flexible portions 502 and relatively rigid portions 504. The relatively flexible portions 502 and the relatively rigid portions 504 can relate to individual keys 108. Individual relatively flexible portions 502 and the relatively rigid portions 504 can be separated by base portions or base 506. Air vents 508 through the relatively flexible portions 502 can evacuate individual keys 108. (e.g., allow air exchange or air flow).

The relatively flexible portion 502 can extend across the extent of the passive keyboard 102 along a first plane (FP) (e.g., a base plane that is parallel to the touch display 106). At the location of individual keys 108, the relatively flexible portion 502 can extend upwardly in biasing zones 510 to a second plane (SP) (e.g., a key plane). In the illustrated configuration, the first plane is positioned along the base 506. The base may be positioned directly on the touch display 106. Some implementations may employ pads 512 between the base 506 and the touch display 106. The pads 512 can directly contact the touch display 106.

Areas of the relatively flexible portion 502 corresponding to individual keys 108 can be secured to relatively rigid portions 504 to form an individual key region 514 that is contacted by a user. Stated another way, keys 108 can include a key region 514 surrounded by biasing zone 510 that resiliently biases the key region 514 away from the first plane (FP). In a resting state (e.g., FIG. 5B), the biasing zones 510 resiliently bias the key region 514 away from the touch display 106 (e.g., in a direction away from the first plane that is opposite to the touch display). In some implementations, the biasing force can be high enough that the user can comfortably rest their fingers on the keys 108 without key activation.

During typing, the user can depress an individual key surface (e.g., surface of key region 514) to force the key surface downward toward the touch display) by applying a downward force (e.g., arrow F in FIG. 5C) that overcomes the resilient bias of the biasing zone 510. The depression of the individual key surface can cause the key 108 to pass through the first plane and to contact the underlying region of the touch display 106 which lies on the opposite side of the first plane from the second plane. (The air vents 510 allow evacuation of the space between the key 108 and the touch display 106 during depression). The contact of the key on the touch display can be interpreted by the device 104 based upon a mapping of the location of the key 108 relative to the overall passive keyboard 102. When the user releases the key 108 (e.g., withdraws force), the biasing zone 510 once again biases the key up (e.g., away from the touch display 106) so that the key rebounds to the biased orientation of FIG. 5B.

During user activation of an individual key 108 (e.g., the deforming and rebounding of the relatively flexible portion 502) the relatively rigid portion 504 can maintain a generally planar configuration. For instance, in both FIGS. 5B and 5C, the relatively rigid portion 504 is generally planar whereas the relatively flexible portion 502 is deformed by the downward force imparted by the user. This feature can provide a haptic feel that many users prefer. In other implementations, the relatively rigid portion may deform more during user activation of the key 108. The deformation and/or rebounding of the relatively flexible portion 502 can provide the snap back property and audible click that simulates a traditional electro-mechanical keyboard feel as preferred by many users.

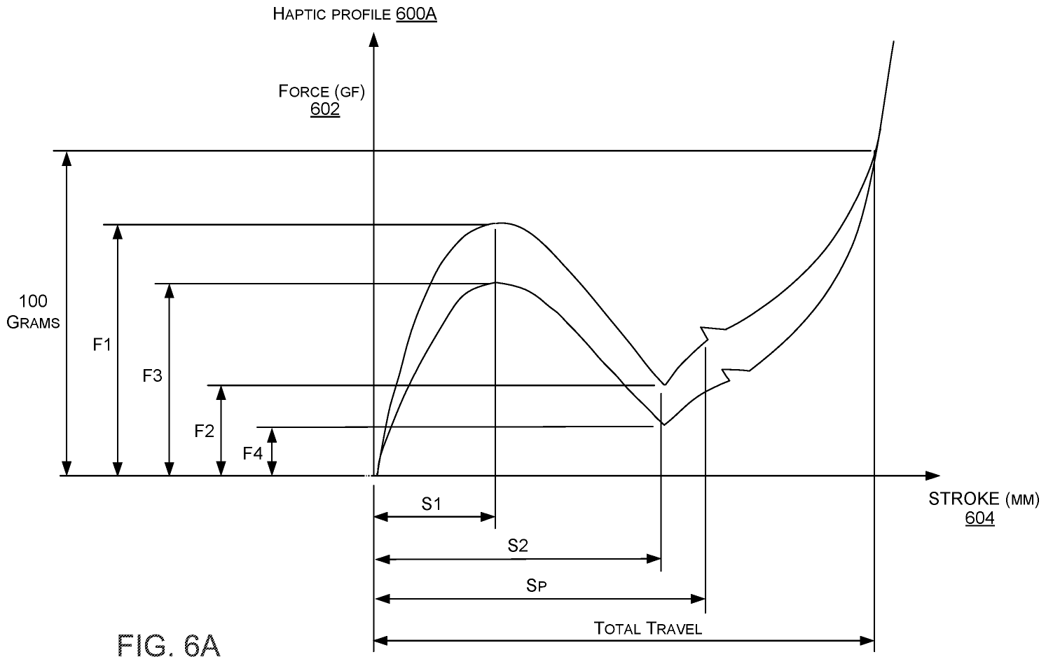

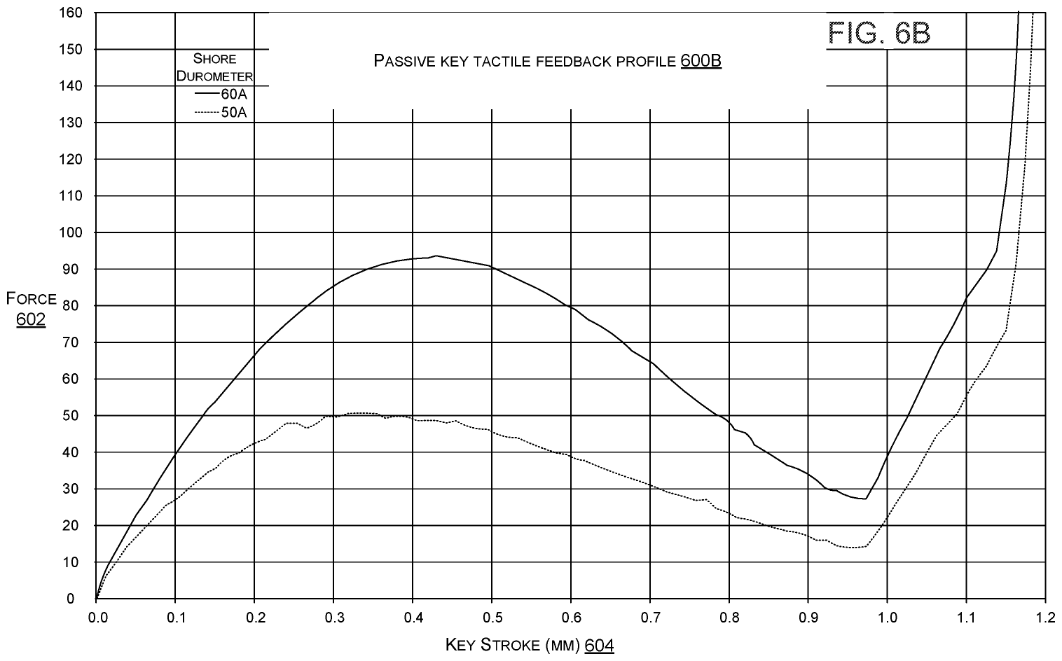

From another perspective, the user's downward force F deforms the biasing zone 510 as the keys 108 moves downward. This deformation creates the vertical key travel and/or haptic snap feel that is similar to a traditional electro-mechanical keyboard and/or the ‘sound’ which is similar to a traditional key activation. (Example haptic snap feel profiles are illustrated relative to FIGS. 6A and 6B). Many users prefer this sensory feedback and think it improves their typing efficiency and/or experience. This sensory feedback can be achieved with one deforming part (e.g., the relatively flexible portion 502).

In contrast to traditional electro-mechanical keyboards, there are no complex assemblies in the example passive keyboards 102 that are difficult to assemble and prone to breakage. Further, there is no chance of electrical failure in the passive keyboard 102—as long as the touch display 106 works, the passive keyboard works. Thus, if a user spills a beverage or other contaminants on a traditional electro-mechanical keyboard the keyboard often shorts out and is ruined. In contrast, with at least some of the present implementations, the passive keyboard could be rinsed off, dried, and be as good as new.

FIGS. 6A and 6B show example ‘haptic snap’ or ‘click ratio’ profiles 600A and 600B, respectively that many users find desirable. The profiles 600A and 600B define force 602 on the vertical axis and key travel 604 on the horizontal axis. These example profiles can be used when selecting dimensions, materials, and/or material thicknesses for passive keyboards to achieve configurations that are consistent with the present concepts. Stated another way, the profiles 600 can allow selection of materials, material properties, such as thickness, relatively flexibility versus relative rigidity, among others, so that audible sounds emitted by the passive keyboard mimics sounds emitted by traditional electro-mechanical keyboards.

Referring again to FIGS. 5A-5C, rather than being rigid like a traditional electro-mechanical keyboard, some of the present implementations of the passive keyboard 102 can be flexible (e.g., deformable) from a planar configuration to a non-planar configuration without harming the passive keyboard 102. This feature can reduce storage space requirements and/or increase reliability. For instance, if the user puts the passive keyboard 102 in their backpack, the passive keyboard can flex (e.g., curve) to accommodate the available space without being damaged.

In some implementations, the entire passive keyboard 102 can be manufactured of a single material, such as a polymer. The material can be configured to create both relatively flexible portions 502 and relatively rigid portions 504. For instance, the relatively rigid portion 504 may be thicker than the relatively flexible portions 502 to decrease flexibility. Alternatively or additionally, the material may be exposed to different conditions at the relatively rigid portions that change the property(s) of the material. In other implementations, the relatively rigid portion 504 can be manufactured from a different material than the relatively flexible material. In some implementations, where the relatively flexible material and/or the relatively rigid material are electrically insulative, one or both may be doped with an electrically conductive material (e.g., dopant) to complete an electrical circuit between the touch display 106 and the user's fingers when a key 108 is depressed.

Various materials can be used to construct the passive keyboard. For instance, in some implementations the relatively flexible material can be manifest as a silicone material, other various elastomers, or various polymers that are flexible at normal operating temperatures (e.g., at temperatures at which a user would be expected to utilize the passive keyboard 102). The relatively flexible material can be formed into the desired shape in various ways, such as molding. The relatively rigid portion 504 can be formed from various materials, such as glass, polycarbonate, other various polymers, or ceramics, among others. The pads 512 can be formed from any suitable substrate material, such as polymers. In some cases, the relatively rigid portions could be positioned in a mold and the relatively flexible portions could be accomplished by injecting a material into the mold and then curing or otherwise changing the material's state.

Although techniques, methods, devices, systems, etc., pertaining to passive keyboards are described in language specific to structural features and/or methodological acts, it is to be understood that the subject matter defined in the appended claims is not limited to the specific features or acts described. Rather, the specific features and acts are disclosed as example forms of implementing the claimed methods, devices, systems, etc.

1. A keyboard, comprising:
relatively flexible portions that defines a base plane and that comprises biasing zones that extend away from the base plane to key regions that define a second plane; and,
relatively rigid portions secured to the key regions, wherein a downward force on an individual key region overcomes a resilient bias of an individual biasing zone and deforms the individual key region across the base plane, and wherein upon removal of the downward force, the individual biasing zone biases the individual key region back to the second plane.

2. The keyboard of claim 1, wherein an entirety of the relatively flexible portions comprises a single material.

3. The keyboard of claim 2, wherein the single material comprises silicone.

4. The keyboard of claim 1, wherein the key regions are transparent.

5. The keyboard of claim 1, wherein an entirety of the keyboard is made from a single material.

6. The keyboard of claim 5, wherein the single material is relatively thicker in the relatively rigid portions and relatively thinner in the relatively flexible portions.

7. The keyboard of claim 5, wherein the single material has different properties in the relatively rigid portions than in the relatively flexible portions.

8. The keyboard of claim 5, wherein the single material includes an electrically conductive dopant.

9. The keyboard of claim 1, wherein the relatively flexible portions define air vents.

10. The keyboard of claim 1, wherein upon removal of the downward force, the individual biasing zone biases the individual key region back to the second plane and creates an audible sound.

11. The keyboard of claim 10, wherein the audible sound mimics a sound emitted by activation of an electro-mechanical keyboard.

12. A keyboard, comprising:
a key defined by a single material that defines a base, a relatively flexible portion, and a key region, the relatively flexible portion extending upwardly from the base to the key region, the relatively flexible portion biasing the key region away from the base; and,
the relatively flexible portion configured to deform when a downward force is applied to the key region to allow the key region to distend downward below the base, the relatively flexible portion configured to rebound upon withdrawal of the downward force and bias the key region back above the base, wherein deforming and rebounding of the relatively flexible portion generates an audible sound.

13. The keyboard of claim 12, wherein the key region remains generally planar during the deforming and the rebounding.

14. The keyboard of claim 12, wherein the relatively flexible portion defines an air vent to allow airflow out of the key during the deforming and into the key during the rebounding.

15. The keyboard of claim 12, wherein the key region is thicker than the relatively flexible portion.

16. The keyboard of claim 12, wherein the single material comprises a polymer.

17. The keyboard of claim 12, wherein the single material is electrically insulative.

18. The keyboard of claim 12, wherein the single material is electrically insulative and includes an electrically conductive dopant.

19. The keyboard of claim 12, wherein the key region is transparent.

20. A system, comprising:
a device having a touch display;
a passive keyboard comprising key regions biased above a base by biasing zones except when individual key regions are forced downward to the base by a user; and,
the device configured to sense a presence of the passive keyboard on the touch display and to interpret activation of a region of the touch display underlying the passive keyboard as an activation of overlying individual key regions by the user.
